(19) United States
(12) Patent Application Publication
(10) Pub. No.: US 2006/0181963 A1
(43) Pub. Date: Aug. 17, 2006

(54) Wireless adaptor for content transfer

(76) Inventors: Richard M. Clayton, Phoenix, AZ (US); Michael T. Gaumond, Scottsdale, AZ (US); David E. Ulmer, Phoenix, AZ (US); Jean-Marc A. Villevieille, Phoenix, AZ (US)

Correspondence Address: GENERAL INSTRUMENT CORPORATION DBA THE CONNECTED;HOME SOLUTIONS BUSINESS OF MOTOROLA, INC., 101 TOURNAMENT DRIVE, HORSHAM, PA, 19044, US

(21) Appl. No.: 11/296,975

(22) Filed: Dec. 8, 2005

Related U.S. Application Data
(60) Provisional application No. 60/651,961, filed on Feb. 11, 2005.
(60) Provisional application No. 60/651,963, filed on Feb. 11, 2005.
(60) Provisional application No. 60/651,960, filed on Feb. 11, 2005.
(60) Provisional application No. 60/651,958, filed on Feb. 11, 2005.
(60) Provisional application No. 60/651,959, filed on Feb. 11, 2005.

(51) Int. Cl. G11B 19/00

(52) U.S. Cl. 369/24.01

(57) ABSTRACT

Described herein are embodiments that wirelessly provide content from a content source to a content player. In one embodiment, there is provided a wireless adaptor that includes a wireless interface operable to receive the content from the content source and a wired interface for a wired connection with the content player to route the content, as received by the wireless interface, for playback by the content player.

### PRIORITY

This application claims the benefit of the following prior filed U.S. Patent Applications: U.S. Provisional Patent Application No. 60/651,961, filed on Feb. 11, 2005, and entitled, “SEAMLESS TRANSACTIONS ACROSS DOMAINS AND DEVICES”; U.S. Provisional Patent Application No. 60/651,963, filed on Feb. 11, 2005, and entitled, “WIRELESS AUDIO ADAPTOR FOR CAR RADIOS”; U.S. Provisional Patent Application No. 60/651,960, filed on Feb. 11, 2005, and entitled, “ZERO INSTALL WIRELESS AUDIO ADAPTOR”; U.S. Provisional Patent Application No. 60/651,958, filed on Feb. 11, 2005, and entitled, “DALY SET WITH MULTIPLE CONTENT CHANNELS”; U.S. Provisional Patent Application No. 60/651,959, filed on Feb. 11, 2005, and entitled, “SUPPLEMENTING DAILY SET WITH HOT CONTENT.” All of the aforementioned provisional applications are hereby incorporated by reference in their entireties.

### RELATED APPLICATIONS

This application incorporates by reference in their entireties the following U.S. Utility Patent Applications all of which are assigned to the assignee of the present application: “WIRELESS ADAPTOR FOR CONTENT TRANSFER” (Attorney Docket No. BCS03803); “GRANTING GREATER RIGHTS TO STORED CONTENT,” (Attorney Docket No. BCS03804); “AUTOMATIC CONTENT UPDATE FOR A TARGET DEVICE” (Attorney Docket No. BCS03805); and “HOT CONTENT UPDATE FOR A TARGET DEVICE” (Attorney Docket No. BCS03806); all of which are hereby incorporated by reference in their entireties.

### BACKGROUND

Portable content players and other devices capable of playing content, such as media like music or videos, are becoming increasingly popular and are typically designed to play the personal content of users. Users tend to use multiple media devices, such as an MP3 digital music player, cellular telephone, personal digital assistant (PDA), personal computer, and a car audio system, and many of these devices are capable as content players for playing the personal content of the users. However, there is currently no fast and convenient way to transfer content between a user's multiple devices. Furthermore, the devices tend to have different user interfaces, so it is inconvenient for a user to learn and operate each device to play music or other content. For instance, some automobile manufacturers offer connector kits for connecting portable music players, such as MP3 players, to the car audio systems in their vehicles. However, these existing connector kits require users to wire connect the portable music players to docks, which further are wire connected to the car audio systems in the vehicles. When a portable music player is docked, its own user interface (display and control buttons) is typically disabled, and the user must use the control buttons belonging to the vehicle's car audio system for limited control of the docked portable music player. Furthermore, the user is typically provided with a limited display of a numeric number to indicate the playing track on the vehicle's dashboard display. Other existing vehicle connector kits are capable of adopting the title navigation of a portable music player for display on a vehicle's dashboard to provide more detailed content information to users. However, such connector kits also require the docking of the portable music player and disabling of the player's user interface (displays and control buttons) when the player is docked.

### SUMMARY

Accordingly, described herein are embodiments that wirelessly provide content from a content source to a content player. In one embodiment, there is provided a wireless adaptor that includes a wireless interface operable to receive the content from the content source and a wired interface for a wired connection with the content player to route the content, as received by the wireless interface, for playback by the content player.

### BRIEF DESCRIPTION OF THE DRAWINGS

Embodiments are illustrated by way of example and not limited in the following figure(s), in which like numerals indicate like elements, in which:

FIG. 1 illustrates a system for content distribution, according to an embodiment;

FIG. 2 illustrates an example of the system for content distribution shown in FIG. 1, according to an embodiment;

FIG. 3 illustrates an operation environment of a wireless adaptor, according to an embodiment;

FIG. 4 illustrates the wireless adaptor in further detail, according to an embodiment;

FIG. 5 illustrates the wireless adaptor in further detail, according to an alternate embodiment; and

FIG. 6 illustrates a method for wireless content transfer, according to one embodiment.

### DETAILED DESCRIPTION

For simplicity and illustrative purposes, the principles of the embodiments are described by referring mainly to examples thereof. In the following description, numerous specific details are set forth in order to provide a thorough understanding of the embodiments. It will be apparent however, to one of ordinary skill in the art, that the embodiments may be practiced without limitation to these specific details. In other instances, well known methods and structures have not been described in detail so as not to unnecessarily obscure the embodiments.

1. System Overview

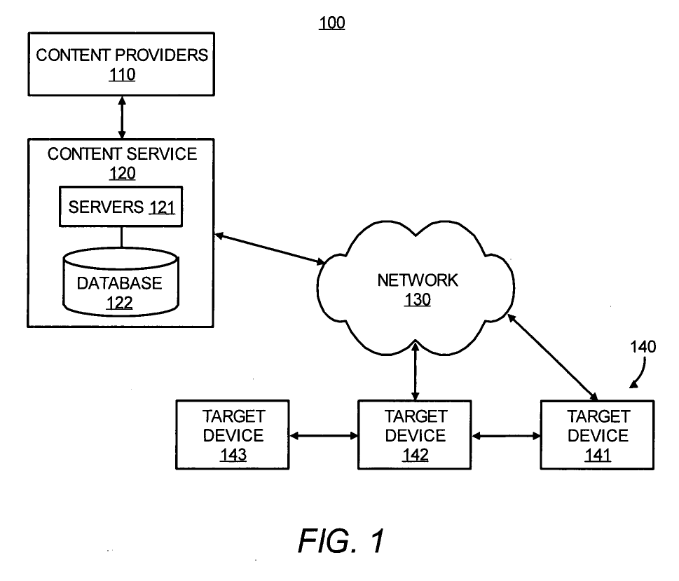

FIG. 1 illustrates a system 100 for content distribution according to an embodiment. The system 100 includes content providers 110, content service 120, network 130 and target devices 140. The content providers 110 include entities configured to provide content that may be played or otherwise consumed by users. Content may include: media such as audio, video, text; multimedia that includes two or more of audio, video and text; or other types of data. Examples of content include but are not limited to media files, such as MP3 files, other types of audio files, video files, textual music play lists, and other types of files. Examples of content providers 110 include but are not limited to news providers (such as local and cable news television stations), television studios, movie studios, music labels, online music (or other media) providers, and others.

Generally speaking, the content providers 110 provide content to the content service 120, such that the content service 120 may provide several functions. One of the functions includes receiving new content from the content providers 110 on a substantially regular basis. Another of the functions includes making the content received from the content providers 110 available to users. In addition, the content service 120 may receive content from multiple content providers 110 to provide users with a relatively large content selection. Users may obtain the content made available by the content service 120 through, for instance, one or both of subscription services and on-demand services.

The content service 120 may also automatically organize content for users and continually provide new content to users. In addition, the content service 120 may perform other functions, such as billing, user information tracking, historical data tracking, etc. The content service 120 may include a server 121 and a database 122 for storing user information and content. The server 121 may facilitate the downloading of content to the target devices 140 used by the users. It will be apparent to one of ordinary skill in the art that the server 121 may include multiple servers and the database 122 may include multiple databases depending on the size and complexity of the content service 120. For example, to support a relatively large number of users, several servers 121 and databases 122 may be needed to harvest content from the content providers 110 and provide content to users with minimal delay.

The network 130 may represent one or more networks. The network 130 may include one or more of private networks, public networks, such as the Internet, wireless networks, such as satellite and cellular networks, and local area wireless networks, such as Wi-Fi or Bluetooth networks, wired networks, local area networks, wide area networks, and any other type of communication network.

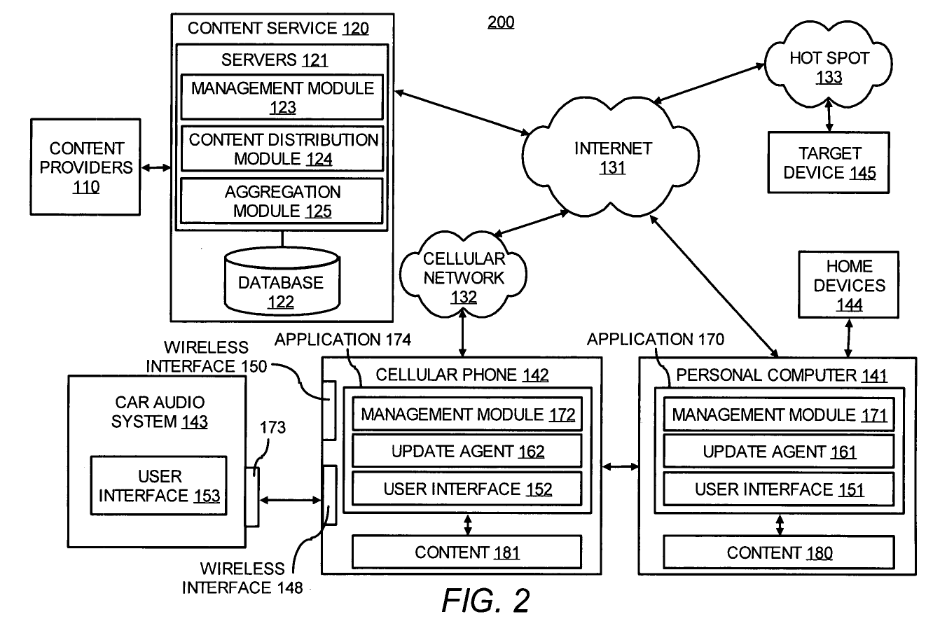

The content service 120 may provide content to the target devices 140 via the network 130. The target devices 140 may download the content from the content service 120, may receive content from one or more other target devices, or may be operable to both download content from the content service 120 and receive content from another target device. For example, as shown in FIG. 1, target devices 141 and 142 are operable to download content from the content service 120 and may be operable to receive content from another target device. As also shown in FIG. 1, the target device 143 is operable to receive content from another target device, such as the target device 142. In this example, the target device 142 may download content from the content service 120 or receive content from the target device 141, and the target device 142 transmits content to the target device 143. The content service 120 and target devices 140 are described in further detail with respect to FIG. 2. Examples of suitable target devices 140 include but are not limited to personal computers, personal digital assistants, cellular telephones, car radio, home stereos, set-top boxes, MP3 players, portable video players, and other end-user devices.

2. Overview of Functionality and Advantages of Content Service

The system 100 provides a media experience for users without requiring a user to change conventional behavior to utilize the content service 120 providing the media experience. For example, the system 100 allows a user to play his or her selected audio content, such as music stations, talk radio, personal content, etc., on one of several target devices 140 that the user may be using at any particular time, such as a car radio in the car, a cellular telephone when the user is on the go, a personal computer or home stereo at home. A target device may carry content selected by the user in a set of channels which are seamlessly available throughout the day on any one of many target devices. The system 100 manages the content and ensures the content is automatically replenished as it is consumed. Furthermore, an interface that is the same as or similar to a conventional device interface may be provided on the target devices 140, so the user may play desired content on any target device in a relatively quick and easy manner.

According to an embodiment, the content service 120 allows a user to configure one or more sets of channels for one or more of the target devices 140. Each channel is populated with content from a content provider or content provided by the user, referred to as the user's personal content. A channel is a data set of content, which may be of a particular type of content. For example, the content service 120 may make available hundreds of stations of content or individual pieces of content. Webcast radio and webcast television are some examples of stations of content. The content service 120 may provide one or more of the stations of content to users as a subscription service, where one or more stations are subscribed to by a user and the content for the stations is sent to one or more target devices for the user. In one example, one or more stations provide large or continuous blocks of Digital Millennium Copyright Act (DMCA) compliant streaming content. Some examples of individual pieces of content include single songs or albums, movies, video clips, etc. The content service 120 may provide an on-demand service where a user can purchase and download individual pieces of content.

Furthermore, channels may include content of a particular type, such as a sports talk channel, a popular music channel, etc. A user may configure a set of channels, hereinafter referred to as a channel set, for example, by selecting content provided by the content service 120 and of interest to the user. The channels may include high-quality, digital content, which may be commercial-free in some instances. A channel in a channel set may also include content from a user's personal collection, such as audio files stored on the user's personal computer. This channel may be programmed by play list, genre, or artist, or any other desired category or set of content.

A user may configure several channel sets, such that the user may use different channel sets at different times. For example, a user may create a first channel set for everyday use, such as for commuting to work. This channel set may include a traffic and news channel, a sports talk radio channel, as well as other channels. The user may create a second channel set for long trips, which may include, for instance, a classic rock channel and a comedy channel.

Content for the channels may be downloaded to one or more of the target devices 140 from the content service 120. The content service 120 may also refresh a target device with new content on a substantially continuous or periodic basis. For example, after content in a channel in a target device is consumed by a user, such as after the content is played, or after content becomes stale, such as after a predetermined period of time has lapsed, the content in the channel may be replenished or replaced with new content received from the content service 120 or new content that was cached in another one of the target devices 140. This update of content on a target device may be performed automatically, and may be beneficial for target devices 140 that have limited storage for storing content, such as a PDA, phone, or other device having a relatively small amount of storage space.

In addition, the target devices 140 may each include an interface that is similar or the same as a conventional user interface widely used in at least one type of today's end user devices. Thus, a user may not be required to learn how to use the interface of a target device. Furthermore, a common interface may be provided on several target devices 140 that may be used by a single user to play content. For example, the common interface may be provided on a user's phone, personal computer, car radio, etc. Thus, the user may not need to learn how to use different interfaces for different target devices 140.

The user interfaces of the target devices 140 may emulate or include the user interfaces of conventional radio or music players with channel presets. The interfaces on the target devices 140 may provide for “one-click” channel selection, similar to clicking a channel preset button on a radio. In one example, each channel may include content populated with a type or genre of music pre-selected by the user, which allows a user to switch with one click between channels similar to switching between different radio stations on a radio. The interface may also allow a user to fast forward, rewind, or pause content.

A software application installed on a user's personal computer allows the user to manage and configure channel sets and update content on multiple target devices. Also, the content that is stored on one target device, may also be available on at least one other target device. Furthermore, the same software application or another software application may be provided on a target device that allows a user to flag songs or other content and add them to a personal wish list for purchase. U.S. patent application entitled, “Granting Greater Rights to Stored Content” (Attorney Docket Number BCS3804) incorporated by reference above describes this feature.

3. Content Service

FIG. 2 illustrates an embodiment of the system 100 for content distribution. The content service 120 is shown as including a management module 123, a content distribution module 124, and an aggregation module 125, in addition to the server 121 and the database 122 discussed with respect to FIG. 1. As referred herein, a module includes one or more software programs, applications, or routines stored on a computer readable medium (CRM) for execution by at least one processor. Embodiments of a CRM include but are not limited to an electronic, optical, magnetic, or other storage or transmission device capable of providing a processor in the receiver with computer-readable instructions. Other examples of a suitable CRM include, but are not limited to, a floppy disk, CD-ROM, DVD, magnetic disk, memory chip, ROM, RAM, an ASIC, a configured processor, any optical medium, any magnetic tape or any other magnetic medium, or any other medium from which a processor can read instructions. In addition, or alternatively, a module may refer to hardware configured to perform one or more functions described herein.

The management module 123 may coordinate information between multiple users. For example, the management module 123 may receive channel configuration information from multiple users, which may include user selections of content for channels in one or more sets of channels for the multiple users. The user selections and channel sets configured by the users may be stored in the database 122 along with additional channel configuration information added by the content service 120, such as permissions and special attributes or rules for content consumption, that is related to the user selections and configurations. The database 122 is queried subsequently to determine the content to provide to the users. In one embodiment, the management module 123 generates a web based user interface which allows a user to log into the content service 120, register with the content service 120 and set preferences, and configure channel sets.

For example, a user connects to the content service 120 via the network 130 shown in FIG. 1, which may include the Internet 131 and/or other networks shown in FIG. 2, using a personal computer 141. The user provides user information to the content service 120, which is stored in the database 122. The management module 123 may prompt a user for channel configuration information, such as a selection of a content type for each channel. For example, the user may select news, traffic, and weather for channel 1, sports talk radio for channel 2, pop music for channel 3, alternative music for channel 4, classic rock music for channel 5, and classical music for channel 6. The management module 123 stores the user selections in the database 122, and channels 1-6 are populated with content corresponding to the associated user selections, and related channel configuration information added by the content service 120, using the content distribution module 124. It should be readily understood that six channels have been described above for purposes of illustration and not of limitation. Therefore, any reasonably suitable number of channels may be available for configuration without departing from the scope of the system 100.

Alternatively, the management module 123 may prompt the user for user information, and channels may be selected for the user based on the user information. For example, the user may provide demographic information or a selection of favorite artists. Several channels may be selected for a channel set for the user based on this information. The user may select some of the channels for a channel set. Default channels may also be provided. Also, several channel sets may be configured for each user.

The content distribution module 124 sends content for channel sets to one or more target devices 140. The content distribution module 124 may determine the content to send to the target devices based on the related channel configuration information. For example, the content distribution module 124 retrieves channel configuration information for a selected set of channels from the database 122. In addition, the content distribution module 124 may send content for the respective channels to one or more target devices 140.

The aggregation module 125 receives, for example, content and play lists from the content providers 110 and stores the information in the database 122, such that the content may be distributed to users as needed.

4. Personal Computer User Gateway for Content Service

Several target devices 140 are shown in FIG. 2. The target devices 140 are shown as comprising a personal computer 141, a cellular telephone 142, a car audio system 143, and a home device 144. These are examples of some target devices 140 that may be used by a user. It will be apparent that other target devices 140 may also be used, such as other portable content device (for instance, MP3 players), vehicle audio systems, home media servers, etc.

Some of the target devices 140 shown in FIG. 2 are connected to the content service 120 via a network. For example, the personal computer 141 is depicted as being connected to the content service 120 via the Internet 131. The cellular telephone 142 is depicted as being connected to the content service 120 via a cellular network 132 and the Internet 131. In addition, a target device 145 is depicted as being connected to the content service 120 via a “hot spot” 133 and the Internet 131. Although not shown, additional target devices 140 may be connected to the content service 120 using one or more private networks, as opposed to a public network such as the Internet 131, and the content service 120 may provide a non-web-based content service. In one embodiment, the content service 120 includes a web service, which the user may log into using the personal computer 141 or another target device. In this embodiment, the content for the channels may be downloaded to one or more target devices 140 via the Internet 131.

The personal computer 141 may include an application 170 having a management module 171, an update agent 161, and a user interface 151. The management module 171 generally allows the user to determine and send channel configuration information for configuring selected channel sets to the content service 120. The channel configuration information may include the selection of content to place in the selected channel sets.

Examples of content that may be selected for a channel set may include genre-oriented music stations, talk content, the user's personal content, etc. Genre-oriented music content may be selected from a catalog listing a relatively large number of stations or individual content provided by the content providers 110. In addition, a single music channel may deliver a continuous set of music tracks on a target device. Talk content may also be selected from a catalog of talk content channels, which may be updated periodically, such as hourly, daily or weekly. In addition, content from more than one content provider may be placed in a single channel set. The user's personal content may be stored on the personal computer 141, which the management module 171 may discover. As such, a user may sort through various content in various manners and may move individual tracks of content or large blocks of content to a channel in a channel set.

The update agent 161 generally receives content from the content service 120 and may refresh content 180 stored on the personal computer 141 on a periodic basis. For instance, the update agent 161 caches the content 180 at the personal computer 141. The content 180 may include content received from the content distribution module 124 of the content service 120.

The update agent 161 also controls the transfer of content 180 to other target devices 140. For example, when the cellular telephone 142 is connected to or otherwise interfaces with the personal computer 141, content for one or more selected channel sets may be transferred to the cellular telephone 142. In one example, the transfer of content 180 may be performed as a substantially automatic feature when the cellular telephone 142 is connected to the personal computer 141, whereby the user does not need to issue a transfer command. The update agent 161 may control the transfer of content 180 to the cellular telephone 142, such that new content may be experienced from one or more play lists.

In addition, the update agent 161 may control the transfer of content 180 to generally enable the new content to be stored on the cellular telephone 142 while staying within the limitations of the cellular telephone's 142 storage capabilities. Thus, at least a portion of the content 180 may be stored on the cellular telephone 142, which is indicated as content 181. Similarly, home devices 144, such as a home stereo or set-top box, may also receive content 180 from the personal computer 141. Instead of a personal computer 141, a server, such as a home media server, or another device may be used to receive and cache content 180 from the content service 120, without departing from a scope of the system 200.

The personal computer 141 may also include a user interface 151 that provides for “one-click” selection of channels and emulates a conventional interface. In one embodiment, the user interface 151 includes a GUI interface that a user may click to control playback and to select a channel. In addition, or alternatively, the user interface 151 may include hardware, such as buttons, wheels, keys, etc.

5. Portable Content Device

A portable content device, such as the cellular telephone 142, PDA, MP3 player, and the like, may include an application 174 having a management module 172, an update agent 162, and a user interface 152. The management module 172 generally allows the user to determine and send channel configuration information for configuring selected channel sets to the content service 120, in manners similar to those described above with respect to the management module 171 of the personal computer 141. In certain instances, the management module 172 may be considered optional for the application 174, since management of the application 174 may be performed by the personal computer 141.

The update agent 162 of the cellular telephone 142 generally controls updating of the content 181, which may include new content received from the content service 120 via the cellular network 132, the Internet 131, a wireless proximity network such as Bluetooth or Wi-Fi (802.11), or any combination thereof, as routed from the content service 120 or through the personal computer 141. For example, the content 181 may comprise new cached content received from the content service 120 as routed through the internet 131 and cellular network 132, as shown in FIG. 2. In another example, the content 181 may comprise new cached content received from the personal computer 141 via a wired connection or a wireless proximity network.

The update agent 162 of the cellular telephone 142 may also manage the receipt of content from one or both of the content service 120 and the personal computer 141. More particularly, for instance, the update agent 162 may control the receipt of one type of content from the content service 120 and another type of content from the personal computer 141. For example, the update agent 162 may control the receipt of content, such that, content required to be updated relatively frequently (hot content), such as traffic information, is received from the cellular network 132. In another example, the update agent 162 may control the receipt of content such that hot content is received from the personal computer 141 before such content expires (without going through the cellular network 132 or any other wireless telecommunication network). In addition, the update agent 162 may control the receipt of cold content, which are content that may be updated less frequently, to be received from the personal computer 141. In this example, the personal computer 141 may download the cold content from the content service 120. Furthermore, when the cellular telephone 142 is connected to or otherwise interfaces with the personal computer 141, the cold content may be updated on the cellular telephone 142. It will be apparent to one of ordinary skill in the art that cold content, such as music, may also be downloaded to the cellular telephone 142 via the cellular network 132.

As shown in FIG. 2, the cellular telephone 142 is also depicted as including a wireless interface 148, which may be used to connect to the content service 120 via hot spots 133, the personal computer 141, other target devices 140, etc. The cellular telephone 142 further includes a wireless interface 150, which may be used to transfer content 181 to the car audio system 143. Alternatively, the wireless interfaces 148 and 150 may combine as a single wireless interface that performs all functions of the wireless interfaces 148 and 150.

Playback of the content 181 may be controlled via the user interface 152 of the cellular telephone 142. For example, the user interface 152 may include controls to enable the selection of a preset channel, to rewind, fast forward, pause, play, etc.

Although not shown, the cellular telephone 142 may comprise a device configured to provide the functionalities of multiple devices. For example, the cellular telephone 142 may include an MP3 player, PDA, camera, video player, etc.

6. Content Player and Wireless Adaptor

A portable content device such as the cellular telephone 142 may send content to a content player such as the car audio system 143 via the wireless interface 150 of the cellular telephone 142. In addition, a wireless adaptor 173 may be used to enable communications between the cellular telephone 142 and the car audio system 143 for receiving content and for controlling playback of the content. The wireless adaptor 173 may be a part of or separate from the car audio system 143. In addition, or alternatively, a wired interface may be used to enable the communications between the cellular telephone 142 and the car audio system 143.

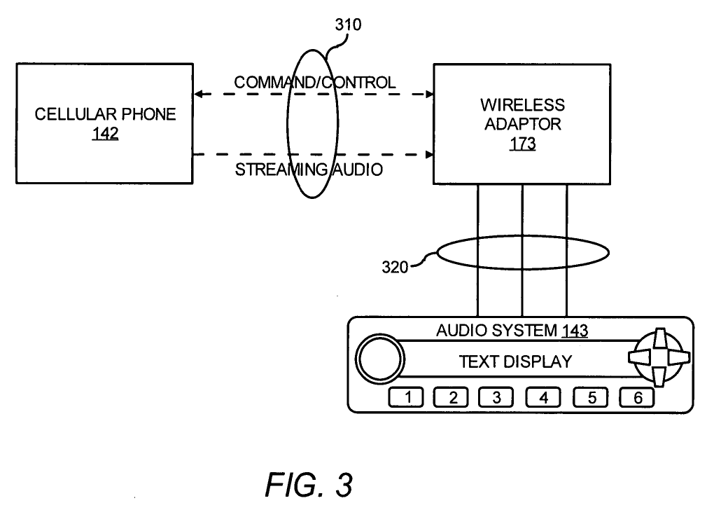

FIG. 3 illustrates an operation environment of the wireless adaptor 173, in accordance with one embodiment wherein the wireless adaptor 173 is separate from the car audio system 143. However, alternative embodiments are contemplated wherein the wireless adaptor 173 is similarly operable when integrated with the car audio system 143. The wireless adaptor 173 allows a suitably-enabled portable content device to wirelessly integrate with a component in a content player. Although FIG. 3 and the description hereinafter refer to the portable content device as a cellular telephone 142, it should be understood that the cellular telephone 142 is used merely as an example, and any other portable content device may be used in its place. Examples of another portable content device include but are not limited to a digital music player and a PDA. Likewise, although FIG. 3 and the description hereinafter refer to a car radio component of a car audio system 143, it should be understood that such a car radio component is used merely as an example, and any other component in the car audio system 143 or any other content player may be used in its place. Examples of a component include but are not limited to a single CD player component, a CD changer component, and an auxiliary component. Examples of another content player include but are not limited to a marine audio system on a boat, a home audio system, and any other audio device or system.

In one embodiment, the wireless adaptor 173 uses a wireless proximity network to establish a wireless communication link 310 with the cellular telephone 142. As referred herein, a wireless proximity network refers to any wireless network that is capable of providing short-range wireless communication links among networked devices. Examples of a wireless proximity network includes but are not limited to Bluetooth and Wi-Fi (802.11). Thus, a wireless proximity network should be differentiated from long-range wireless networks, such as cellular networks for cellular or mobile phones and satellite communication networks. Additionally, the wireless adaptor 173 is operable to be wire-connected at 320 to an available I/O interface on the car audio system 143. Examples of such an input connection include but are not limited to an I/O interface for an additional CD changer, a satellite radio, or any other auxiliary (AUX) I/O interface for any other audio component.

In one embodiment, the cellular telephone 142 is suitably-enabled to wirelessly transmit content and command/control signals, encoded or unencoded, via the aforementioned wireless proximity network to the wireless adaptor 173. In turn, the wireless adaptor 173 provides any needed signal conversion or decoding of such content and command/controls for forwarding to the car audio system 143. Thus, the wireless adaptor 173 provides an interface that allows the cellular telephone 142 to transmit stored content to the car audio system 143 for content playback by the car radio component.

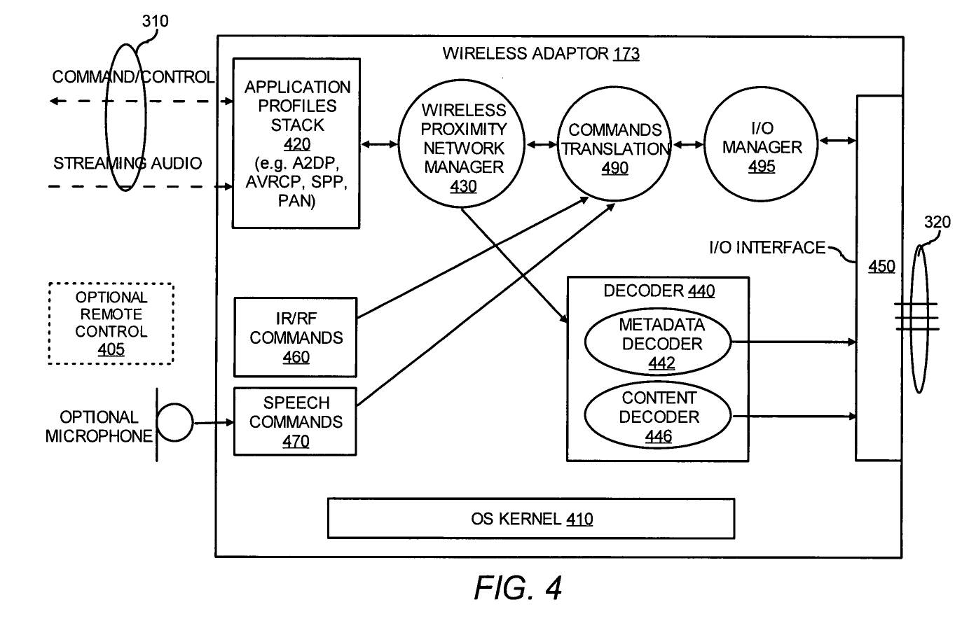

FIG. 4 illustrates the wireless adaptor 173 in further detail, in accordance with one embodiment. The wireless adaptor 173 includes an Operating System (OS) kernel 410 that manages the device's hardware and software operations, an application profiles stack 420 for the wireless proximity network that provides the wireless communication link between the car audio system 143 and the cellular telephone 142 via the wireless adaptor 173, a decoder 440 having a content decoder 446 that decodes the content received from the cellular telephone 142 and an optional metadata decoder 442 that decodes any metadata for the content (e.g., song titles, artist names, playlists) for displaying on the car audio system 143. In one embodiment, the content decoder 446 and metadata decoder 442 are implemented as program code, encoded on a CRM. Thus, it is possible to include in the program code for the metadata decoder 442 the particular display format for the car audio system 143 to enable the displaying of the content metadata on the car audio system 143 as normally displayed on the cellular telephone 142. Such particular display format may be obtained from the manufacturer of car audio system 143, which may be the Original Equipment Manufacturer (OEM) that is the car manufacturer or an after-market manufacturer. The wireless adaptor 173 also includes hardware (not illustrated) for a baseband controller and radio that is used to receive radio-frequency (RF) signals from the cellular telephone 142 and converting them into digital signals for processing by the applications profile stack 420. Thus, the RF hardware and the applications profile stack 420 provide the wireless adaptor 173 with a wireless interface for communication with the cellular telephone 142.

Once the content and any associated metadata are decoded, they are forwarded to the car audio system 143 via an input/output (I/O) interface 450, which may be a part of the wireless adaptor 173 as shown in FIG. 4 or implemented as a separated connector wired out from the wireless adaptor 173. The I/O interface 450 is physically linked or wired connected to the available I/O interface on the car audio system 143 to enable the wired communication link 320 (shown in FIG. 3) between wireless adaptor 173 and the car audio system 143. The wireless adaptor 173 also includes an I/O manager 495 that manages the I/O interface 450 of the wireless adaptor 173 for connection to the car audio system 143 and a commands translation module 490, which is described below.

The commands translation module 490 includes program code, encoded on a CRM, suited for translating command/control signals between the cellular telephone 142 and the car audio system 143, as facilitated by the wireless proximity network and the I/O interface 450. In one embodiment, it is possible to include in the program code any standard or generic audio profile so that the wireless adaptor 173 is operable with different car audio systems from different manufacturers that use such standard or generic audio profile. For instance, different manufacturers may use the same standard audio profile for controlling one or more components in their car audio systems, such as the preset station buttons and the station seek up/down buttons of a car radio component. Thus, it is possible to leverage such standard audio profile to translate command/control signals from the car audio system 143 back to the cellular telephone 142 for different types of car audio system. Likewise, the I/O interface 450 may be a standard or generic I/O interface so that the wireless adaptor 173 is operable to be connected to the I/O interface of different car audio systems from different manufacturers that have such standard or generic I/O interface. For instance, different manufacturers may include the same standard I/O interface for input and output of control signals relating to one or more components in their car audio systems, such as the control signals for the car audio component, the CD player component, or both.

In another embodiment, the wireless adaptor 173 is specific for the car audio system 143 of each manufacturer, wherein the commands translation module 490 includes program code that is specific for the audio profile that is proprietary to the particular manufacturer. In such instance, the proprietary audio profile may be obtained from the particular manufacturer. Alternative embodiments are contemplated, wherein updated software code may be wirelessly downloaded from the cellular telephone 142, or any other suitable device by wired or wirelessly, to the wireless adaptor 173 in the same manner as content is transmitted from the cellular telephone 142. Thus, the commands translation module 490 in the wireless adaptor 173 may be provided with software updates for the component in the car audio system 143 for which it is initially intended or another component in the same car audio system 143 or a different car audio system for which it is to be intended. For instance, a user who wishes to use the wireless adaptor 173 in different cars with different car audio systems may download suitable program code for command/control that is specific for use in each car.

Likewise, when the car audio system 143 is provided with a particular I/O interface by its manufacturer, the wireless adaptor 173 is to include an I/O interface 450 unique to the car audio system 143 to facilitate a successful connectivity between the two I/O interfaces.

To manage the communication links 310 and 320 for wireless transfer of content from the cellular telephone 142 to the car radio system 143, the wireless adaptor 173 further includes a proximity wireless network manager 430 that runs the application profiles stack 420 to set up and control the wireless communication link 310, interacts with the decoder 440 to decode content and any content metadata, and interacts with the commands translation module 490 and the I/O manager 495 to set up and control the wired communication link 320 for forwarding the decoded content and content metadata to the car radio system 143. In one embodiment, the network manager 430 includes program code, encoded on a CRM, for performing the aforementioned functions.

FIG. 4 illustrates one example of the applications profile stack 420 having a number of Bluetooth profiles to regulate the transmission of content from the cellular telephone 142 to the car audio system 143 and the transmission of command/control signals between these two devices. In one embodiment, the applications profile stack 420 is implemented as program code encoded on a CRM. Examples of Bluetooth profiles that may be used in the applications profile stack 420 include but are not limited to the Advanced Audio Distribution Profile (A2DP), the Audio Video Remote Control Profile (AVRCP), the Serial Port Profile (SPP), the Hands-Free Profile (HFP), the Extended Service Discover Profile (ESDP), and the Personal Area Network (PAN) profile. In order for the wireless adaptor 173 and the cellular telephone 142 to work together through the Bluetooth transport, the cellular telephone 142 also includes the same Bluetooth profiles found in the wireless adaptor 173. Although FIG. 4 and the description herein refer to the use of Bluetooth profiles, it should be understood that the profiles used merely depend on the type of wireless proximity network used to provide the communication link between the cellular telephone 142 and the car audio system 143.

When the wireless adaptor 173 is in operation, the A2DP therein enables the wireless adaptor 173 to transfer the content stored in the cellular telephone 142 to the car audio system 143 as streaming audio for stereo audio playback through the later. As described earlier, the stored content is located in respective channels in the cellular telephone 142. The network manager 430 further controls the content decoder 446 to decode the streaming audio into a format understood by the car audio system 143 for output to the I/O interface 450, to which the car audio system 143 is connected through its own I/O interface. The SPP provides each of the cellular telephone 142 and car audio system 143 with a virtual serial port for wireless connection, through emulation of RS-232 control signal communication, between the devices (rather than with an actual serial cable) to form the wireless proximity network. Thus, the SPP may be used in place of the A2DP to transfer content from the cellular telephone 142 to the car audio system 143 and further provide remote control use of the cellular telephone 142 by the car audio system 143. Additionally, the HFP may be included to allow the car audio system 143 to handle incoming phone calls to the cellular telephone 142 as well. The AVRCP also may be used in place of the SPP for wireless connection to ensure interoperability of functional controls between the cellular telephone 142 and the car audio system 143 for content access and playback. As referred herein, a function control of a device is a control that is capable of controlling a function of such device. Thus, both the SPP and AVRCP enable the cellular telephone 142 to be remotely controlled by the car audio system 143 via the wireless proximity network. For instance, the SPP or AVRCP enables the car audio system 143 to act as a controller that sends audio command/control signals to the cellular telephone 142 for playback of the audio stream. Examples of command/control signals include playback, stop, channel selection, or display mode, depending on the nature of the devices involves, namely the cellular telephone 142 and the wireless adaptor 173 in this instance, and the desired scenario for accessing the audio stream through the car audio system 143. In one embodiment, the wireless adaptor 173 includes a switch to provide the user with an option to either maintain or disable the user interface on the cellular telephone 142 for control upon connection of the wireless adaptor 173 to the car audio system 143 and establishment of the wireless proximity network. As a result, the cellular telephone 142 is controllable by the functional controls on its own user interface, the functional controls on the user interface of the car audio system 143, or both.

The PAN profile allows the Bluetooth devices involved to participate in a personal area network that is used for communication among devices in proximity to each other. In this case, the involved Bluetooth devices are the car audio system 143 that is Bluetooth-enabled by the wireless adaptor 173 and the cellular telephone 142 that is Bluetooth-enabled and in proximity to the wireless adaptor 173 (for example, in the same car where the car audio system 143 is installed). Thus, the PAN profile allows the car audio system 143 to send its status and identification information to the cellular telephone 142, via the I/O interface 450 as managed by the I/O manager 395 and translated by the command translation module 490, so as to establish a communication link with the cellular telephone 142. The PAN profile also may be used to transfer content from the cellular telephone 142 to the car audio system 143.

The ESDP employs a detection protocol that allows a Bluetooth device to discover any other Bluetooth device that in proximity to the wireless adaptor 173, and hence the car audio system 143, and to establish a communication link with the nearby Bluetooth device over a network (such as a personal area network) with a network profile (such as the PAN profile). Thus, the wireless adaptor 173 supports a detection protocol that enables a target device, such as the car audio system 143, to dynamically detect a portable content device, such as the cellular telephone 142, and to automatically interface with the cellular telephone 142 for audio streaming therefrom without requiring any user's interaction. For example, a user having a powered-up cellular telephone 142 in a pocket, a brief case, a purse, or a glove compartment in a car equipped with the car audio system 143 and a connected wireless adaptor 173 does not need to retrieve the cellular telephone 142 and activate the audio streaming function. Instead, the car wireless adaptor 173 automatically detects the presence of the cellular telephone 142 and initiate the audio streaming from the cellular telephone 142 to the car audio system 143 if the car audio system 143 is already on or powered up or upon such powered up. Thus, from the perspectives of the cellular telephone 142 and the user, it matters not what target device is connected to the wireless adaptor 173 because of the seamless integration and standardization of functions provided by the wireless adaptor 173.

Accordingly, the wireless adaptor 173 enables the cellular telephone 142 to be played and controlled in a natural and intuitive manner with familiar user interfaces already found in existing target devices and with minimal user interaction. For example, the preset radio-station buttons for a car radio component of the car audio system 143 are operable to access the various different content channels available in the cellular telephone 142, and the seek buttons for the same car radio component are operable to skip forward or backward the content in a particular content channel, if the content includes the user's content or individual pieces of content that is controllable in such a manner. In another example, the play, forward, and backward functions available for a CD player in the audio system are operable to control the play, forward, and backward functions for accessing content in the portable content device, if the content includes the user's content or individual pieces of content that is controllable in such a manner. In still another example, for a CD changer in the audio system, the next disc, last disc, and disc selection functions are operable to control the next channel, last channel, and channel selection functions for accessing the content in the portable content device.

In one embodiment, the wireless adaptor 173 optionally includes an infra-red (IR), radio-frequency (RF), or IR and RF command module 460 to enable remote control of the audio car audio system 143 via a remote control 405, and a speech command module 470 to enable control of the wireless adaptor 173 via voice command. The IR/RF command module 460 and the speech command module 470 are operable in place of or in conjunction with one another. Furthermore, each is operable in place of or in conjunction with the application profile stack 173 and the network manager 430. When the user employs the remote control 405 to control the content playback of the audio stream from the cellular telephone 142 through the car audio system 143, the IR/RF control signals from the remote control 405 are received by the IR/RF command module 460 via an IR/RF receiver (not shown). The IR/RF command module provides conversion of the IR/RF control signals into corresponding electrical signals for forwarding to the command translation module 490, which then provides translation of such electrical signals to control the cellular telephone 142, the car audio system 143, or both. Likewise, the speech command module 470 enables a user to give voice commands to control the content playback of the audio stream from the cellular telephone 142 through the car audio system 143. The voice commands are converted into electrical signals by the speech command module 470 for forwarding to the command translation module 490, which then provides translation of such electrical signals to control the cellular telephone 142, the car audio system 143, or both.

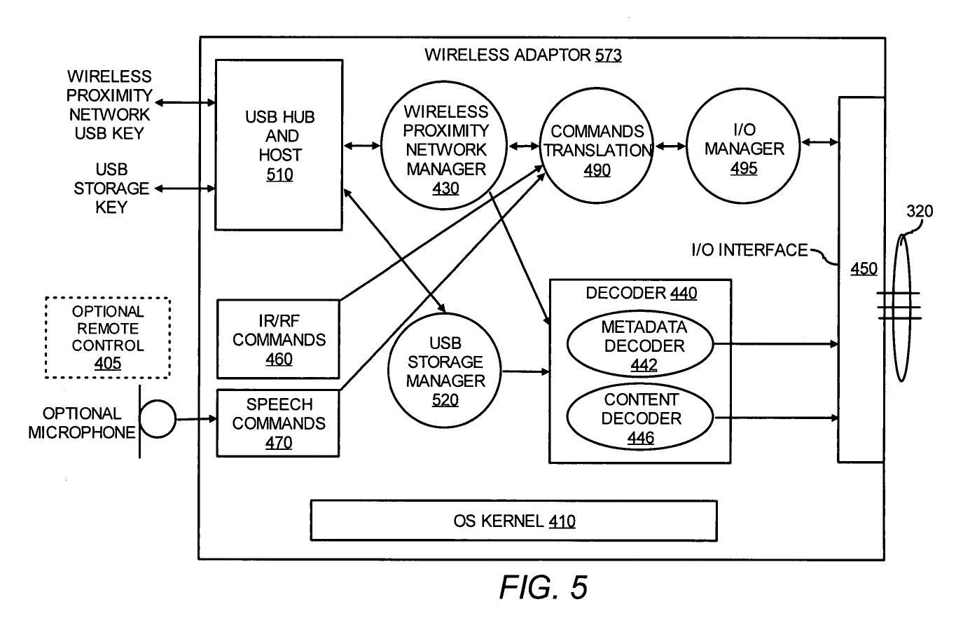

FIG. 5 illustrates a wireless adaptor 573, in accordance with an alternate embodiment. As with the wireless adaptor 173, the wireless adaptor 573 includes the OS kernel 410, the network manager 430, the decoder 440 with the metadata decoder 442 and the content decoder 446, a commands translation module 490, the I/O manager 495, and the I/O interface 450. However, the wireless adaptor 573 includes a Universal Serial Bus (USB) hub and host 510 in place of the application profiles stack 420.

The USB hub and host 510 enables a connection of a transceiver for a proximity wireless network. The transceiver includes the functionality of the application profiles stack 420 described earlier for the wireless adaptor 173 in FIG. 4. For instance, a Bluetooth or Wi-Fi USB key is operable for connection to the USB hub and host 510 to establish the wireless communication between the cellular telephone 142 and the car audio system 143 via the wireless adaptor 573 as described earlier. Although FIG. 5 illustrates a USB connection, it should be noted that other types of connection are also applicable. For instance, one alternate connection is a Firewire (IEEE 1394).

The USB storage manager 520 manages the retrieval and transfer of any content and content metadata stored on any USB storage key that is connected to the wireless adaptor 573 via the USB hub and host 510, to the car audio system 143 as streaming audio for stereo audio playback and metadata display through the later. Thus, the USB hub and host 510 acts a wired interface that allows a content storage device to be connected to the wireless adaptor 573 for content transfer. As with the transfer of content from the cellular telephone 142, the content and content metadata from the USB storage key are decoded by the decoder 440 for playback and displayed, respectively, by the car audio system 143.

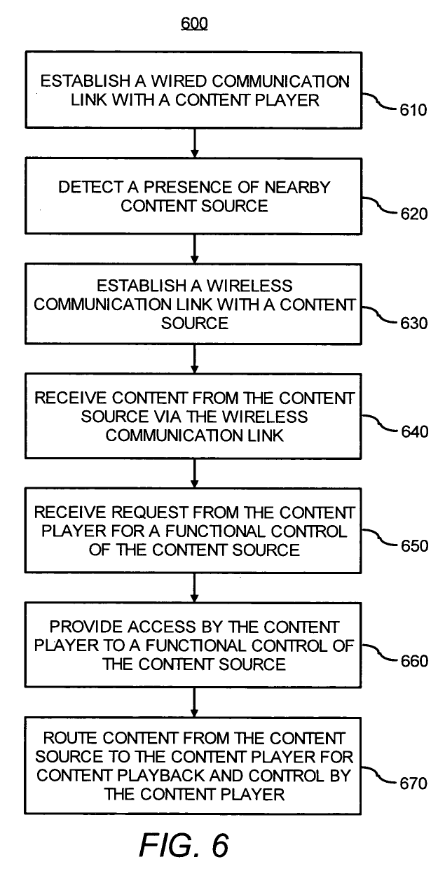

FIG. 6 illustrates a method 600 for wirelessly providing a content stored in a content source, such as the cellular telephone 142, to a content player, such as the car audio system 143. The method 600 is described with respect to FIGS. 1-5 by way of example and not of limitation. It will thus be apparent to one of ordinary skill in the art that the method 600 may be performed with systems and devices other than those depicted in FIGS. 1-5.

Referring now to FIG. 6, at 610 the wireless adaptor 173 (or 573) establishes a wired communication link with a content player, such as the car audio system 143, through an I/O interface on the wireless adaptor 173, such as the I/O interface 450, wire-connected to an I/O interface on the content player. At 620 the wireless adaptor 173 (or 573 with a connected transceiver) detects a presence of a content source nearby or in proximity to the wireless adaptor 173 (or 573). At 630 the wireless adaptor 173 (or 573) also establishes a wireless communication link with a nearby content source, such as the cellular telephone 142, through a wireless proximity network, such as a Bluetooth or Wi-Fi network, to access the content stored in the cellular telephone 142. As described earlier, the content stored in cellular telephone 142 may have been previously downloaded from the content service 120 via the Internet 131, cellular network 132, and optionally through the personal computer 141. The wireless proximity network is facilitated by the application profiles stack 420, in the case of the wireless adaptor 173, or a transceiver such as a Bluetooth or Wi-Fi USB key that is connectible to the wireless adaptor, in the case of the wireless adaptor 573.

At 640, the wireless adaptor 173 (or 573) receives content, such as audio content, from the content source via the wireless communication link as established wireless proximity network. At 650, the wireless adaptor 173 (or 573) also receives a request from the content player for a functional control of the content source, such as a selection of a content channel available in the content source. At 660, the wireless adaptor 173 (or 573) provides the content player with access to a functional control of the content source, as facilitated by the applications profiles stack 420. At 670, the wireless adaptor 173 (or 573) provides the content from the content source to the content player for content playback and control by the content player. The content playback also can include a display of content information at the content player.

According to one embodiment, the wireless adaptors 173 and 573 in FIGS. 4 and 5 include both hardware and software. In one embodiment, each of the wireless adaptors 173 and 573 is implemented as a System-on-a-Chip (SoC) solution, with one or more computer chips, each includes one or more processors, such as microprocessors or digital signal processors, and one or more CRMs that include program codes for the implementation of the application profiles stack 420, the network manager 430, the commands translations module 490, the I/O manager 495, the decoder 440, the IR/RF commands module 470, and the speech commands module 470.

What has been described and illustrated herein are various embodiments along with some of their variations. The terms, descriptions and figures used herein are set forth by way of illustration only and are not meant as limitations. Those skilled in the art will recognize that many variations are possible within the spirit and scope of the subject matter, which is intended to be defined by the following claims—and their equivalents—in which all terms are meant in their broadest reasonable sense unless otherwise indicated.

What is claimed is:

1. A method for wirelessly providing content comprising the steps of:
wirelessly receiving content from a content source through a wireless proximity network;
routing, through a wired connection, the content as wirelessly received to a content player for playback of the received content;
receiving a request from the content player for access to at least one functional control of the content source to command playback of the received content; and
responsive to the request, providing the content player with the access to the at least one functional control of the content source via at least one functional control of the content player.

2. The method of claim 1, wherein the wireless proximity network is one of a Bluetooth network and a Wi-Fi network, and the content includes audio content.

3. The method of claim 1, wherein the content source is a portable device that stores the content and is enabled to wirelessly transmit the content through the wireless proximity network.

4. The method of claim 3, wherein the portable device is one of a cellular telephone, a personal digital assistant, and a digital music player.

5. The method of claim 1, wherein the content player is a car audio system.

6. The method of claim 1, further comprising the steps of:
wirelessly receiving metadata for the content from the content source through the wireless proximity network; and
routing, through the wired connection, the metadata as wirelessly received to the content player for display on the content player.

7. The method of claim 3, further comprising the steps of:
establishing the wireless proximity network with the portable device prior to wirelessly receiving the content; and
providing a user of either the portable device or the content player with an option for one of maintaining a user interface on the portable device for access by the user and disabling the user interface on the portable device to prevent access by the user.

8. The method of claim 6, wherein the step of establishing the wireless proximity network comprises the steps of:
automatically detecting a presence of the portable device in proximity to the content player; and
automatically establishing the wireless proximity network based on the automatic detecting the presence of the portable device.

9. The method of claim 1, further comprising the steps of:
receiving a voice command for a functional control of one of the content source and the content player; and
automatically operating one of the content source and the content player in accordance with the functional control from the voice command.

10. The method of claim 1, further comprising the steps of:
receiving a remote command, from a remote source different from the content source, for a functional control of one of the content source and the content player; and
automatically operating one of the content source and the content player in accordance with the functional control from the remote command.

11. A computer readable medium on which is encoded program code, the program code comprising:
program code for establishing a wireless proximity network with a content source;
program code for receiving content from the content source through the wireless proximity network, wherein the content includes audio content;
program code for playback of the content as received at a content player through a wired connection;
program code for receiving metadata for the content from the content source through the wireless proximity network; and
program code for displaying the metadata as received at the content player through the wired connection.

12. The computer readable medium of claim 11, further comprising:
program code for receiving a command from the content source for a functional control of one of the playback of the content and the displaying of the metadata at the content player; and
program code for translating the command from a content source to a command for content player to execute the functional control.

13. The computer readable medium of claim 12, further comprising:
program code for receiving a voice command from a source different from the content source for the functional control; and
program code for translating the voice command to the command for the content player to execute the functional control.

14. The computer readable medium of claim 13, further comprising:
program code for receiving a wireless remote command from a source different from the content source for the functional control; and
program code for translating the wireless remote command to the command for the content player to execute the functional control.

15. A wireless adaptor for wirelessly providing content to a content player comprising:
a wireless interface operable to form a wireless proximity network with a content source to wirelessly receive the content from the content source; and
a wired interface that provides a wired connection with the content player to route the content, as received by the wireless interface, for playback by the content player.

16. The wireless adaptor of claim 15, wherein the wireless interface is further operable to receive metadata of the content, and the wired interface further provides a routing of the metadata through the wired connection to the content player for displaying of the metadata at the content player.

17. The wireless adaptor of claim 15, wherein the wireless interface is separate from the wireless adaptor and operable to be wire-connected to the wireless adaptor.

18. The wireless adaptor of claim 15, further comprising:
a commands translation module operable to receive a command for a functional control of the playback of the content from the content source via the wireless interface and translate the command for execution by the content player.

19. The wireless adaptor of claim 16, further comprising:
a content decoder module that decodes the content and the metadata, as received at the wireless interface, for transmission to the content player through the wired interface.

20. The wireless adaptor of claim 18, further comprising:
a remote command module operable to receive a wireless command from a remote source different from the content source and to convert the wireless command into the command for the functional control received by the commands translation module.

21. The wireless adaptor of claim 18, further comprising:
a voice command module operable to receive a voice command from a source different from the content source and to convert the voice command to the command for the functional control received by the commands translation module.

22. The wireless adaptor of claim 15, wherein the wireless interface comprises:
an applications stack module operable to automatically detect a presence of the content source in proximity to the wireless adaptor, route the content from the content source to wired interface, and enable a control at the content player of at least one function of the content source that is otherwise controlled at the content source.

23. The wireless adaptor of claim 15, wherein the content includes multimedia content.

24. The wireless adaptor of claim 15, further comprising:
a content interface operable to provide a connection of another content source to the wireless adaptor to receive content stored in another content source for playback by the content player.

25. The wireless adaptor of claim 17, further comprising:
a content interface operable to provide a connection of another content source to the wireless adaptor to receive content stored in another content source for playback by the content player, wherein the separate wireless interface is wire-connected to the wireless adaptor at the content interface.
